(19) United States
(12) Patent Application Publication
(10) Pub. No.: US 2025/0154005 A1
(43) Pub. Date: May 15, 2025

(54) A PROCESS FOR CONVERSION OF AQUEOUS HYDROGEN SULFIDE TO SULFURIC ACID

(71) Applicant: Topsoe A/S, Kgs. Lyngby (DK)

(72) Inventors: Samuel Wiktor Scherman JOHANSSON, Copenhagen 0 (DK); Morten THELLEFSEN, Hillenzid (DK); Michael Thomas SYLVEST-JOHANSEN, Gentofte (DK)

(73) Assignee: Topsoe A/S, Kgs. Lyngby (DK)

(21) Appl. No.: 18/837,364

(22) PCT Filed: Feb. 20, 2023
(86) PCT No.: PCT/EP2023/054230

§ 371 Date: Aug. 9, 2024

(30) Foreign Application Priority Data
Feb. 22, 2022 (DK) PA202200144

(51) Int. Cl. C01B 17/79; C01B 17/50; C01B 17/80; C02F 1/20; C02F 101/10; C02F 103/10; C02F 103/16; C02F 103/28; C02F 103/34

(52) U.S. Cl. CPC C01B 17/79; C01B 17/508; C01B 17/80; C02F 1/20; C02F 2101/101; C02F 2103/10; C02F 2103/16; C02F 2103/28; C02F 2103/343

(57) ABSTRACT

The present disclosure relates to a process for purification of an aqueous solution comprising hydrogen sulfide comprising the steps of a. directing an amount of recycle gas to contact the aqueous solution comprising hydrogen sulfide, to separate a gas comprising hydrogen sulfide from the aqueous solution, b. heating said gas comprising hydrogen sulfide optionally after addition of a source of oxygen to provide a process feed gas, c. in a hydrogen sulfide oxidation step directing said process feed gas to oxidation of hydrogen sulfide to sulfur dioxide, d. in a sulfur dioxide oxidation step directing said sulfur dioxide rich gas to contact a material catalytically active in oxidation of sulfur dioxide to sulfur trioxide, to provide a sulfur trioxide rich gas e. in a condensation step cooling said sulfur trioxide rich gas, to enable hydration of sulfur trioxide and condensation of sulfuric acid to provide a stream of concentration sulfuric acid and a purified process gas, and in a recycling step, directing at least a part of the purified process gas as said recycle gas.

### TECHNICAL FIELD

The present invention relates to the field of purification of waste water containing sulfides, specifically generating concentrated sulfuric acid from a contaminated aqueous solution of hydrogen sulfide.

### BACKGROUND ART

The mining and metallurgical industry has the objective of maximum yield of metals. This may involve methods such as leaching of metals from ore by dissolving the metals in sulfuric acid, to provide aqueous solutions of metals sulfates.

Precipitation of metal sulfides from metal processing water and microbiological systems is practiced for reduction of sulfate to form sulfide in combination with recuperation of excess sulfur by a further microbiological step of oxidation of excess sulfide to sulfur. This will serve a purpose of withdrawing sulfur from the aqueous solution, but the recuperated sulfur will contain a high amount of metal impurities, such that the sulfur is not suited for immediate use.

Conversion of pure elemental sulfur to sulfuric acid may be carried out by combustion of sulfur to sulfur dioxide, catalytic oxidation of sulfur dioxide to sulfur trioxide and provision of concentrated sulfuric acid either by hydration of sulfur trioxide and condensation of sulfuric acid or absorption of sulfur trioxide in concentrated sulfuric acid.

With the contaminated sulfur from the waste water purification process, combustion of sulfur would result in high amounts of particulate matter, which in catalytic processes would cause blockages and a short life time of catalysts.

A similar relevance of converting sulfates or sulfides to sulfuric and may also be found in processes in the paper and pulp industry, in waste water streams in the pharmaceutical industry and in sulfuric acid hydrolysis of lignocellulose to form fermentable compounds, and the present process may also be applicable for treating waste water from such processes.

### SUMMARY OF INVENTION

With the present disclosure a more efficient process is proposed which recuperates sulfide to provide sulfuric acid. The sulfuric acid may be used in leaching processes or traded commercially, and hydrogen sulfide may also be recuperated from aqueous solutions originating from other processes.

In the present process the microbiological conversion of hydrogen sulfide to elemental sulfur is not required, since hydrogen sulfide instead is directed to catalytic oxidation to sulfur dioxide, which is further treated to provide concentrated sulfuric acid in a wet gas sulfuric acid (WSA) plant.

Further synergy may be available by use of sulfuric acid for ore leaching and/or by use of the purified process gas as stripping medium to drive sulfide from the microbiological reaction, but the process outlined is suitable for conversion of aqueous hydrogen sulfide in a wide range of feedstocks to sulfuric acid.

### Definitions

For the purpose of the present application, the unit wt % shall designate weight/weight % and the unit vol % shall designate volume/volume %. The unit ppmᵥ shall designate volumetric parts per million.

For the purpose of the present application, where concentrations in the gas phase are given, they are, unless otherwise specified, given as volume/volume (i.e. molar) concentrations.

For the purpose of the present application, where concentrations in the liquid or solid phase are given, they are, unless otherwise specified, given as weight/weight concentrations.

A broad aspect of the present disclosure relates to a process for purification of an aqueous solution comprising hydrogen sulfide comprising the steps of directing an amount of recycle gas to contact the aqueous solution comprising hydrogen sulfide, to separate a gas comprising hydrogen sulfide from the aqueous solution comprising hydrogen sulfide, heating said gas comprising hydrogen sulfide optionally after addition of a source of oxygen to provide a process feed gas, in a hydrogen sulfide oxidation step directing said process feed gas optionally after addition of a source of oxygen under conditions efficient in oxidation of hydrogen sulfide to sulfur dioxide, to provide a sulfur dioxide rich gas, in a sulfur dioxide oxidation step directing said sulfur dioxide rich gas optionally after addition of a source of oxygen to contact a material catalytically active in oxidation of sulfur dioxide to sulfur trioxide under conditions efficient in catalytic oxidation of sulfur dioxide to sulfur trioxide, to provide a sulfur trioxide rich gas, in a condensation step cooling said sulfur trioxide rich gas by heat exchange with a condenser heat exchange medium, such as process gas or air, to enable hydration of sulfur trioxide and condensation of sulfuric acid to provide a stream of concentration sulfuric acid and a purified process gas, and in a recycling step, directing at least a part of the purified process gas as said recycle gas.

This has the associated benefit of such a process being effective in transferring an amount of hydrogen sulfide to the gas phase and converting it to sulfur dioxide and subsequently sulfuric acid, even if hydrogen sulfide is present in low concentrations.

In a second aspect said conditions efficient in oxidation of hydrogen sulfide to sulfur dioxide involve an elevated temperature, e.g. obtained by combustion possibly in combination with heat exchange.

This has the associated benefit of such a process being able to convert hydrogen sulfide to sulfur dioxide at low temperature with energy efficiency.

In a third aspect said conditions efficient in oxidation of hydrogen sulfide to sulfur dioxide involve contact with a material catalytically active in oxidation of hydrogen sulfide to sulfur dioxide.

This has the associated benefit of such a process being able to convert hydrogen sulfide to sulfur dioxide at low temperature with energy efficiency.

In a fourth aspect the amount of hydrogen sulfide in the process feed gas is at least 0.1 vol % or 0.5 vol % and less than 2 vol % or 3 vol %.

This has the associated benefit of such a process being able to receive a low concentration of hydrogen sulfide and convert it to sulfuric acid.

In a fifth aspect the amount of dioxygen in the purified process gas is at least 0.1 vol % or 0.5 vol % and less than 3 vol % or 5 vol %.

This has the associated benefit of such moderate concentrations of dioxygen does not interfere significantly with the sulfate reducing microorganisms, while ensuring at least 0.5 vol %, 1 vol % or even 3 vol % dioxygen in the process gas contacting said material catalytically active in sulfur dioxide oxidation.

In a sixth aspect said material catalytically active in oxidation of hydrogen sulfide to sulfur dioxide involves a catalytically active material comprises one or more oxides of a metal taken from the group consisting of vanadium, chromium, tungsten, molybdenum, cerium, niobium, manganese and copper on a support comprising one or more oxides of metals taken from the group of aluminum, silicon and titanium and a temperature being at least 200° C. or 220° C. and less than 500° C. or 550° C.

This has the associated benefit of providing a material at moderate cost enabling the oxidation of hydrogen sulfide at moderate temperature.

In a seventh aspect conditions efficient in catalytic oxidation of sulfur dioxide to sulfur trioxide involve a catalytically active material comprising vanadium pentoxide (V₂O₅), sulfur in the form of sulfate, pyrosulfate, tri- or tetrasulfate and alkali metals, such as Li, Na, K, Rb or Cs, on a porous carrier and a temperature being at least 380° C. or 400° C. and less than 700° C. or 650° C.

This has the associated benefit of providing a stable material having moderate cost enabling the oxidation of sulfur dioxide at moderate temperature.

In an eighth aspect heating said process gas comprising hydrogen sulfide involves one or both of (a) heat exchange in a heat exchanger with a first hot process fluid and (b) addition of a second hot process gas.

This has the associated benefit of enabling operation above a required catalyst ignition temperature with the energy of the process.

In a ninth aspect said first hot process fluid and second hot process fluid may be the same or different and may be taken from the group of a heat exchange medium including said condenser heat exchange medium, said sulfur dioxide rich gas, said sulfur trioxide rich gas and said purified process gas.

This has the associated benefit of these streams providing recuperated released heat from exothermal processes.

In a tenth aspect said process feed gas has a temperature such that the temperature of the sulfur dioxide rich gas is at least 370° C. and less than 420° C.

This has the associated benefit that it may be avoided to heat the process gas between the material catalytically active in hydrogen sulfide oxidation and the material catalytically active in sulfur dioxide oxidation, which simplifies the process layout and increases the energy efficiency of the plant operation and is enabled by an operational range of the material catalytically active in hydrogen sulfide oxidation.

In a eleventh aspect said aqueous solution comprising hydrogen sulfide is provided by microbiological reduction of sulfate.

This has the associated benefit of providing a solution for environmental challenges related to sulfate, while providing a source of sulfuric acid.

In a twelfth aspect at least an amount of the sulfuric acid produced is directed to be used for leaching of metal ore, to provide an aqueous solution comprising metal sulfate.

This has the associated benefit of providing a solution for the metallurgical industry, while at the same time providing a source of sulfuric acid for processes in the industry.

A further aspect of the present disclosure relates to a process plant comprising a vessel for contacting a liquid stream and a gas stream, having a liquid stream inlet and outlet and a gaseous stream inlet and outlet, a means for hydrogen sulfide oxidation and a sulfur dioxide reactor containing a material catalytically active in sulfur dioxide oxidation, each having an inlet and an outlet and a condenser, having a cooling medium inlet and a cooling medium outlet, a gas inlet, a liquid outlet and a gas outlet, wherein the gas outlet of the vessel for contacting a liquid stream and a gas stream is in fluid communication with the inlet of the hydrogen sulfide oxidation reactor, the outlet of the hydrogen sulfide oxidation reactor is in fluid communication with the inlet of the sulfur dioxide oxidation reactor, the outlet of the sulfur dioxide oxidation reactor is in fluid communication with the gas inlet of the condenser and the gas outlet of the condenser is in fluid communication with the gaseous stream inlet of the vessel for contacting a liquid stream and a gas stream.

This has the associated benefit of being an efficient plant for converting an aqueous sulfide stream to sulfuric acid. The means for hydrogen sulfide oxidation may either be a thermal means, such as an incinerator optionally having a further inlet for fuel or a reactor containing a material catalytically active in hydrogen sulfide oxidation.

### Technical Problem

Aqueous solutions containing sulfates (and sulfides) are environmentally undesired and regulated, and it is desired to recuperate and convert the sulfate/sulfide to a more attractive sulfur compound, such as sulfuric acid.

This includes aqueous waste and intermediate streams from metallurgical processing including mining which may contain metals of value and sulfur compounds, such as sulfate, which are undesired in the environment. Processes for removal of these metals which are cost efficient and environmentally benign are desired.

In metal extraction from mining processes, a common process involves leaching of ore by sulfuric acid, which releases metal sulfates in an aqueous stream. The metals of this stream may be precipitated and reduced, to provide pure metals. Such processes are used for a wide range of metals, notably Ni, Cu and U as well as rare earth metals.

The sulfur in the aqueous waste and intermediate streams from such metallurgical processing including mining is undesired in the environment. Therefore, cost efficient and environmentally benign processes for removal of the sulfur are desired.

A similar relevance of converting sulfates or sulfides to sulfuric and may also be found in processes in the paper and pulp industry, in waste water streams in the pharmaceutical industry and waste streams from sulfuric acid hydrolysis of lignocellulose to form fermentable compounds, and the present process may also be applicable for treating waste water from such processes.

A common technology in this perspective is the microbiological sulfide generation, in which a culture of sulfate reducing microorganisms reduces sulfate to sulfide, to precipitate a metal sulfide sludge, from a solution with excess sulfide. As sulfides (including H₂S) are environmentally undesired, a common process has been to direct the sulfide containing waste water to be oxidized to elemental sulfur by sulfide oxidizing microorganisms, such that the sulfur may be withdrawn. This microbiologically produced sulfur will contain an amount of metals, and thus not be immediately suited for further processing, unless purified.

The present disclosure relates to an alternative to this process in which the aqueously formed hydrogen sulfide is directed to the gas phase and further to a wet gas sulfuric acid process plant in which the process gas comprising hydrogen sulfide is catalytically oxidized to form a process gas comprising sulfur dioxide. The process gas comprising sulfur dioxide may then be directed to contact a material catalytically active in sulfur dioxide oxidation to sulfur trioxide, which is hydrated to form sulfuric acid, which may be condensed in an air cooled condenser, from which liquid concentrated sulfuric acid and purified process gas is withdrawn.

The step of driving H₂S to the gas phase may be carried out with the aid of a stripping medium and is beneficially carried out in a stripper column ensuring good contact between gas and liquid. Since the sulfate reduction to sulfide requires reducing conditions, absence or low presence of oxygen is desired.

To optimize the integrated process includes limiting the amount of oxygen in the stripping medium (recycle gas). However, a certain surplus of O₂ is required in the sulfuric acid process to keep the catalysts oxidized and a suitable compromise between the need for anaerobic conditions for the bacteria and oxidizing conditions for the sulfuric acid process is in the range 1-5 vol % O₂ in the off gas from the sulfuric acid process.

The sulfate reducing microorganisms have limited optimal operating condition ranges, including a limited pH range, and therefore an amount of CO₂ may be added to the substrate to control the pH. If this amount of CO₂ is added with the source of oxygen, it may also be recycled, and the consumption of CO₂ will be limited.

Both the CO₂ concentration and O₂ concentration of the recycled purified process gas may be changed to more optimal values if desired. This can e.g. be accomplished by adding another gas stream to the purified gas stream, characterized by having a higher CO₂ concentration and lower O₂ concentration than the purified gas stream.

The O₂ concentration in the purified process gas can also be reduced by adding a reductant to the purified process gas and let the O₂ and reductant react, optionally by means of a suitable catalyst or microorganisms. The reductant could e.g. be H₂, producing water with the reaction with O₂ or methanol, producing CO₂ and water.

The step of catalytically oxidizing hydrogen sulfide to sulfur dioxide has commonly been carried out by combustion, either with hydrogen sulfide as the only fuel or with the addition of a support fuel, to ensure a temperature above the required 700° C. for combustion. However where a high concentration of hydrogen sulfide, such as above 25 vol %, is not available, the process will instead beneficially involve directing the process feed gas to contact a catalytically active material comprising one or more oxides of an active metal taken from the group consisting of vanadium, chromium, tungsten, molybdenum, cerium, niobium, manganese and copper on a refractive support comprising one or more oxides of metals taken from the group of aluminum, silicon and titanium. An example of a material would contain from 1 wt %, 2 wt % or 3 wt % to 4 wt %, 5 wt %, 10 wt %, 25 wt % or 50 wt % V₂O₅, a stabilizing constituent, preferably 2 wt % or 3 wt % to 5 wt %, 10 wt % or 50 wt % WO₃, and one or more supports taken from the group consisting of Al₂O₃, SiO₂, SiC, and TiO₂ and it may additionally contain 1 wt % to 5 wt % of a metal taken from the group consisting of chromium, molybdenum, cerium, niobium, manganese and copper. Optionally if the porous support comprises TiO₂ this may preferably be in the form anatase with the associated benefit of TiO₂ and especially anatase being highly porous and thus active as catalyst supports. Alternatively, the porous support may comprise SiO2 preferably being in the form of diatomaceous earth or a highly porous artificial silica with the associated benefit of SiO₂ and especially diatomaceous earth and highly porous artificial silica being highly porous, and thus active as catalyst supports.

The material catalytically active in hydrogen sulfide oxidation may be in the form of pellets or extrudates in a reactor bed or in the form of a monolithic catalyst, preferably comprising a structural substrate made from one of metal, high silicon glass fibres, glass paper, cordierite and silicon carbide and a catalytic layer with the associated benefit of providing a stable and well defined physical shape. The monolithic catalyst may have a void of from 65 vol % or 70 vol % to 70 vol % or 85 vol %, with the associated benefit of a good balance between the amount of catalytic material and an open monolith with low pressure drop. The catalytic layer of said monolithic catalyst may have a thickness of 10-150 μm with the associated benefit of providing a catalytically active material with high pore volume.

Depending on the type of material the ignition temperature of the oxidation reaction may be from 200° C. or 220° C. and up to 300° C. or 320° C., which is above the temperature of the feed gas comprising hydrogen sulfide, so heating of this gas may be required prior to contacting the material catalytically active in oxidation of hydrogen sulfide. Furthermore, since the amount of oxygen directed to the aqueous solution of sulfide is desired to be low, it may be desired to add a source of oxygen, such as atmospheric air or oxygen enriched air. The heating and addition of an oxygen source may be provided by a single means, if the oxygen source is provided at a sufficiently elevated temperature. As the H₂S oxidation reaction is exothermal, the sulfur dioxide rich process gas will have an increased temperature, if the process is operated adiabatically, as it commonly is.

Ideally, the outlet temperature from the H₂S oxidation step corresponds to the optimal inlet temperature to the SO₂ oxidation step, such that there will be no need to adjust the temperature between the two oxidation steps and process design is simple.

If the temperature or the heating value of the feed to the H₂S oxidation step is insufficient, the optimal inlet temperature to the SO₂ oxidation step may be established either by increasing the inlet temperature to the H₂S oxidation step or the heating value of the feed to the H₂S oxidation step, e.g. if the temperature increase in the H₂S oxidation step is 50° C., an inlet temperature to the H₂S oxidation step could be 350° C., providing 400° C. at the inlet to the SO₂ oxidation step.

For feed gases with higher heating values it may not be possible to limit the outlet temperature from the H₂S oxidation step to provide a suitable inlet temperature to the SO₂ oxidation step by adjusting the inlet temperature. If the temperature increase in the H₂S oxidation step is e.g. 250° C., the minimum inlet temperature to the SO₂ oxidation step will be 450-470° C., i.e. higher than the optimal inlet temperature. The temperature can be lowered by installing a simple heat exchanger between the two oxidation steps or, more energy efficient, by adding a recycle loop around the H₂S oxidation step, making it easy to control inlet and outlet temperatures of the H₂S oxidation step.

An amount of O₂ required for oxidation of H₂S and subsequently SO₂, must be added to the process. Depending on the availability and temperatures it may be beneficial to add this either upstream or downstream the material catalytically active in oxidation of H₂S. The step of catalytically oxidizing sulfur dioxide to sulfur trioxide in a so-called SO₂ converter will beneficially involve a catalytically active vanadium sulfate melt material comprising vanadium pentoxide (V₂O₅), sulfur in the form of sulfate, pyrosulfate, tri- or tetrasulfate and alkali metals, such as Li, Na, K, Rb or Cs, on a porous carrier such as silica or alumina. The porous carrier of the material catalytically active in oxidation of sulfur dioxide may be silica such as a diatomaceous earth with less than 2 wt % and preferably less than 1 wt % of alumina. The alkali metal content is at least 2 wt %, 4 wt % or 8 wt % and less than 16 wt %, 20 wt % or 24 wt %. The V₂O₅ content is at least 1 wt %, 2 wt % or 4 wt % and less than 10 wt %, 12 wt % or 15 wt %. The sulfur content is at least 1 wt %, 2 wt % or 3 wt % and less than 10 wt %, 18 wt % or 20 wt % sulfur in the form of sulfate, pyrosulfate, tri- or tetrasulfate.

The ignition temperature for this exothermal oxidation process is typically around 370° C. to 400° C. and the maximum temperature commonly 650° C. or 700° C. However, since the equilibrium shifts towards SO₂ at elevated temperatures, multiple beds with interbed cooling is often practiced, but in the present case the concentration of SO₂ is so low that one or two beds will commonly be the most efficient. In this step oxygen is consumed, and the ignition temperature, at which the reaction is active over the catalytically active material, may also not be fulfilled here. Typically, addition of a sufficient amount of oxygen would be made upstream the material catalytically active in oxidation of hydrogen sulfide, but it may be beneficial to provide heating of the gas rich in sulfur dioxide. A beneficial source of heat would be a heat exchange medium used between the process beds or at the outlet of the SO₂ converter, since the temperature would be above the required 370° C. to 400° C.

The final conversion step in the process is the condensation of hydrated SO₃ as sulfuric acid. Being an oxidation of hydrogen sulfide stripped from an aqueous solution, the process gas streams would contain an amount of water, and thus SO₃ is hydrated to form H₂SO₄, which may be condensed as concentrated sulfuric acid in a condenser, provided that an appropriate amount of nucleation seeds and cooling is provided, as it is known from the wet gas sulfuric acid process. The cooling medium is typically atmospheric air, which is heated from ambient temperature to around 180-270° C. in the condenser, while the process gas is typically cooled from 290° C. to 100° C. The heated cooling medium would be suitable to provide at least an amount of the thermal energy and/or oxygen required for ignition and oxidation of the hydrogen sulfide.

The process gas outlet from the condenser will contain a small amount of unconverted sulfur dioxide and unused oxygen as well as nitrogen and other inert compounds. An amount of this purified gas may be recycled for use as stripping medium to release gaseous hydrogen sulfide from the aqueous solution comprising hydrogen sulfide. To avoid excessive buildup of inert gases in the gas loop, an amount of gas would also have to be withdrawn as a purge stream from the process.

The concentrated sulfuric acid produced by wet gas sulfuric acid process plant may be used in the upstream leaching process.

The purified gas from the wet gas sulfuric acid process will contain O₂, H₂O, N₂, SO₂ and SO₃ and if CO₂ is added or a support fuel is combusted, CO₂. Recycling an amount of this purified gas may influence the amount of inert composition of the flue gas significantly, and also influence the amount of e.g. sulfur released to the environment, since in addition to the sulfur captured as sulfuric acid, an amount is captured in the recycle.

### BRIEF DESCRIPTION OF DRAWINGS

FIG. 1 shows a process integrating stripping of hydrogen sulfide with a wet gas sulfuric acid plant.

FIG. 1 shows a process plant where an aqueous solution containing hydrogen sulfide (2) is directed to be contacted by a recycle gas (42) in a gas/liquid contacting device (4), such as a stripping column. The contacting device releases a liquid outlet stream (6), with a reduced amount of sulfide and a H₂S containing gaseous stream (8), which typically would contain 0.5-2% H2S. The H₂S containing gaseous stream (8) is optionally heated and directed as process feed gas to a material catalytically active in oxidation of H₂S (10), which provides an SO₂ rich gas (11). The SO₂ rich gas (11) is combined with an amount of oxygen rich gas (12), such as atmospheric air which may be the heated cooling medium (34) of the condenser (30) and directed to an SO₂ converter (18), where it contacts a first bed of material catalytically active in oxidation of SO₂ to SO₃ (20), which releases heat, to be recuperated in an interbed heat exchanger (22), before being directed to a second bed of material catalytically active in oxidation of SO₂ to SO₃ (24) which may be similar to or different from the first bed of catalytically active material (20). The oxidized process gas out of the second bed of catalytically active material (24) is directed to a further heat exchanger (26) before being directed as oxidized process gas (28) to a condenser (30). The heat recuperated in the two heat exchangers (22 and 26) may beneficially directed to heat the H₂S containing gaseous stream (8) and/or the SO₂ rich stream (16) to enable sufficient temperatures for initiating reaction on the catalysts.

The condenser (30) receives a stream of cooling medium (32), typically atmospheric air, which is heated in the condenser to form heated cooling medium (34). When this is atmospheric air, it may conveniently be directed as the oxygen rich gas (12), to increase the temperature of the inlet gas to the material catalytically active in SO₂ oxidation (16). In the condenser, SO₃ is hydrated and condensed as sulfuric acid (36) and desulfurized process gas is released (38). The desulfurized process gas (38) is split in purge gas (40) and recycle gas (42).

In a specific embodiment the aqueous solution comprising sulfide (2) may be a process stream from a metal sulfide precipitation stream. In this case, it may be beneficial to add an amount of CO₂ with the recycle gas (42), to control pH in the aqueous solution comprising sulfide, to provide optimal solutions for the sulfate reducing bacteria.

In a number of positions heat integration may be beneficial, although not illustrated in the Figure. Thermal energy obtained in the two heat exchangers (22 and 26) and in the heated cooling medium (34) of the condenser may be used to heat up the process gas from the stripper column anywhere between the outlet of the stripper column to the inlet of the SO₂ converter (18). Heating may be required prior to the catalytically active materials active in H₂S oxidation (10) and SO₂ oxidation (20), to increase the temperature above the catalyst ignition point. As the typical materials catalytically active in oxidation of hydrogen sulfide are thermally robust, it may be beneficial to heat the process feed gas (8) to a higher temperature than required, to avoid heating between the material catalytically active in oxidation of hydrogen sulfide (10) and the material catalytically active in oxidation of sulfur dioxide (18). Such heat integration is not shown in detail, but it may be obtained by heat exchange or addition of a hot stream.

Depending on the specific situation It may also be less costly or necessary to add thermal energy from an extraneous source, such as an electrical or a fired heater.

### FIG. 2

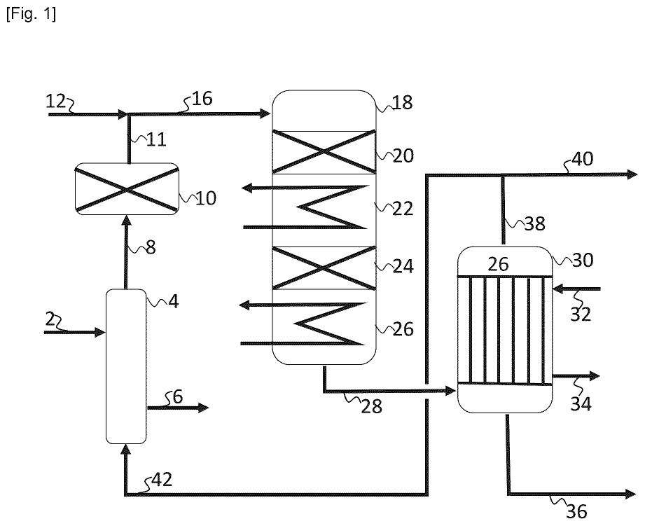

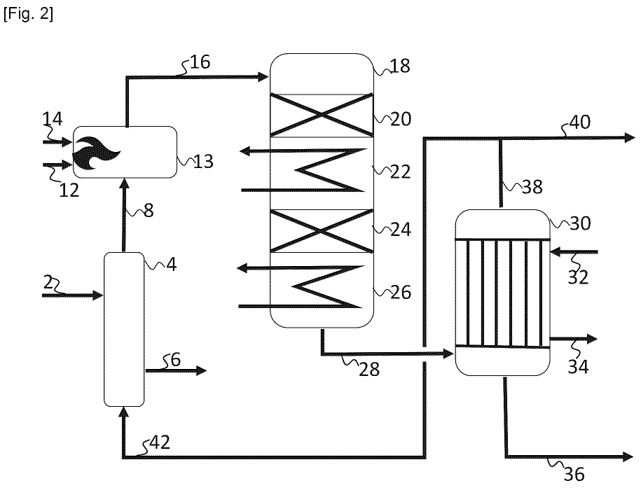

FIG. 2 shows a similar process plant with thermal incineration of H₂S. Here an aqueous solution containing hydrogen sulfide (2) is directed to be contacted by a recycle gas (42) in a gas/liquid contacting device (4), such as a stripping column. The contacting device releases a liquid outlet stream (6), with a reduced amount of sulfide and a H₂S containing gaseous stream (8), which typically would contain 0.5-2% H2S. The H₂S containing gaseous stream (8) is directed as process feed gas (8) to an incinerator (13), receiving an amount of oxygen rich gas (12), such as atmospheric air which may be the heated cooling medium (34) of the condenser (30), and a fuel such as natural gas (14) to provide a SO₂ rich gas (16). The SO₂ rich gas (16) is directed to an SO₂ converter (18), where it contacts a first bed of material catalytically active in oxidation of SO₂ to SO₃ (20), which releases heat, to be recuperated in an interbed heat exchanger (22), before being directed to a second bed of material catalytically active in oxidation of SO₂ to SO₃ (24) which may be similar to or different from the first bed of catalytically active material (20). The oxidized process gas out of the second bed of catalytically active material (24) is directed to a further heat exchanger (26) before being directed as oxidized process gas (28) to a condenser (30). The heat recuperated in the two coolers (22 and 26) is beneficially directed to heat the H₂S containing gaseous stream (8) to reduce the required amount of support fuel, but contrary to FIG. 1, the recuperated heat is not of value in other positions of the process.

The condenser (30) receives a stream of cooling medium (32), typically atmospheric air, which is heated in the condenser (30) to form heated cooling medium (34). When this is atmospheric air, it may conveniently be directed as the oxygen rich gas (12), to increase the temperature of the inlet gas to the incinerator (13). In the condenser, SO₃ is hydrated and condensed as sulfuric acid (36) and desulfurized process gas is released (38). The desulfurized process gas (38) may be split in purge gas (40) and recycle gas (42).

### EXAMPLES

To illustrate the benefit of the integrated process producing sulfuric acid, possibly for use on site, an example of the process illustrated in FIG. 1 is provided, as well as a process with thermal oxidation of H₂S by combustion of a support fuel in accordance with FIG. 2.

A specific example is not provided for the current practice of selective microbiological oxidation of H₂S to elemental sulfur. While it may appear beneficial, the microbiological processes available unfortunately generate sulfur of a quality, which without further purification is insufficient for use, e.g. to generate sulfuric acid to be used for ore leaching. This sulfur may be further purified and sold for the purpose of use as e.g. fertilizer, but there is no immediate use of the sulfur on site.

In the two specific examples the process feed gas corresponds to a gas which could be obtained by stripping H₂S from an aqueous solution such as microbiologically reduced sulfate and adding a minimal viable amount of oxygen for stable operation. The oxygen was added downstream the material catalytically active in H₂S oxidation as atmospheric air, from the cooling side of a sulfuric acid condenser, which generates a process feed gas at a temperature of 200-230° C. which is sufficient for ignition in the material catalytically active in H₂S oxidation.

The product of catalytic H₂S oxidation can be heated further by heat exchange with the heat exchange medium of the SO₂ converter or the condenser, recuperating heat of the SO₂ oxidation to SO₃. Alternatively, the inlet temperature to the H₂S oxidation catalyst can be chosen, such that the outlet temperature from the H₂S oxidation catalyst fits the inlet temperature of the SO₂ oxidation catalyst, which simplifies the design of the sulfuric acid plant. Such optimal inlet temperature can be obtained by proper heating of the feed gas from the stripper column, optionally combined with a recycle of converted process gas from outlet of H₂S oxidation catalyst to inlet of H₂S oxidation catalyst. The overall process is exothermal, with export of 11 t/h steam at 244° C.

Commonly for abatement of H₂S, it is oxidized thermally by incineration aided by a support fuel. For the present process this is illustrated in FIG. 2, and an alternative example is provided in Table 2. Here the material catalytically active in H₂S oxidation is replaced by an incinerator, which requires addition of 3.9 t/h of natural gas as support fuel to achieve the required temperature for thermal oxidation of H₂S. In addition, combustion air for the oxidation of the natural gas must be added. As a result, the total volume of process gas (and thus equipment) is 58% higher in the process shown in Table 2 compared to Table 1. The addition of support fuel results in an increased export of steam, which in this example is 86 t/h at 249° C.

A comparison of the two examples, clearly demonstrates the benefit of the process illustrated in Table 1, in that the equipment size is significantly smaller. In addition, a consumption of 3.9 t/h natural gas as support fuel is avoided. This reduced use of support fuel of course has the consequence that steam export is reduced by 75 t/h. When the process is implemented in a metallurgy process, the produced sulfuric acid will in addition provide the benefit that sulfuric acid is produced locally, without a need for importing.

TABLE 1

| | Stream: | 8 | 12 | 16 | 28 | 38 | | 36 | |
|---|---|---|---|---|---|---|---|---|---|
| CH₄ | [% vol] | | | | | | | | |
| CO₂ | [% vol] | 10 | | 8.71 | 8.82 | 8.99 | | | |
| H₂S | [% vol] | 1.4 | | | | | | | |
| N₂ | [% vol] | 80.6 | 78 | 80.55 | 81.56 | 83.14 | | | |
| O₂ | [% vol] | 3 | 21 | 3.58 | 3.03 | 3.09 | | | |
| SO₂ | [% vol] | 0 | | 1.22 | 480 ppmᵥ | 489 | ppmᵥ | | |
| SO₃ | [% vol] | 0 | | 0 | 0.52 | 0 | ppmᵥ | | |
| H₂SO₄ | [% vol] | 0 | | 0 | 0.66 | 10 | ppmᵥ | 97 | wt % |

| | | | | | | | | |
|---|---|---|---|---|---|---|---|---|
| H₂O | [% vol] | 5 | 1 | 5.83 | 5.24 | 4.6 | 3 | wt % |

| | | | | | | | |
|---|---|---|---|---|---|---|---|
| T | [° C.] | 35 | 213 | 400 | 265 | 100 | 40 |
| Flow | [T/h] | 131 | 20 | 151 | 151 | 145 | 6.1 |

TABLE 2

| | Stream: | 8 | 12 | 14 | 16 | | 28 | 38 | | 36 | |
|---|---|---|---|---|---|---|---|---|---|---|---|
| CH₄ | [% vol] | | | 100 | | | | | | | |
| CO₂ | [% vol] | 10 | | | 8.39 | | 8.46 | 8.56 | | | |
| H₂S | [% vol] | 1.4 | | | | | | | | | |
| N₂ | [% vol] | 80.6 | 78 | | 76.39 | | 77.08 | 78 | | | |
| O₂ | [% vol] | 3 | 21 | | 3.38 | | 3.04 | 3.08 | | | |
| SO₂ | [% vol] | | | | 0.75 | | 231 ppmᵥ | 234 | ppmᵥ | | |
| SO₃ | [% vol] | | | | 229 | ppmᵥ | 0.22 | 0 | ppmᵥ | | |
| H₂SO₄ | [% vol] | | | | 8.5 | ppmᵥ | 0.54 | 10 | ppmᵥ | 97 | wt % |

| | | | | | | | | |
|---|---|---|---|---|---|---|---|---|
| H₂O | [% vol] | 5 | 1 | 10.68 | 10.24 | 9.93 | 3 | wt % |

| | | | | | | | | |
|---|---|---|---|---|---|---|---|---|
| T | [° C.] | 35 | 220 | 30 | 400 | 265 | 100 | 40 |
| Flow | [T/h] | 131 | 98.5 | 3.9 | 233 | 233 | 227 | 6.1 |

1. A process for purification of an aqueous solution comprising hydrogen sulfide comprising the steps of
a. directing an amount of recycle gas to contact the aqueous solution comprising hydrogen sulfide, to separate a gas comprising hydrogen sulfide from the aqueous solution comprising hydrogen sulfide,
b. optionally heating said gas comprising hydrogen sulfide optionally after addition of a source of oxygen to provide a process feed gas,
c. in a hydrogen sulfide oxidation step directing said process feed gas optionally after addition of a source of oxygen under conditions efficient in oxidation of hydrogen sulfide to sulfur dioxide, to provide a sulfur dioxide rich gas,
d. in a sulfur dioxide oxidation step directing said sulfur dioxide rich gas optionally after addition of a source of oxygen to contact a material catalytically active in oxidation of sulfur dioxide to sulfur trioxide under conditions efficient in catalytic oxidation of sulfur dioxide to sulfur trioxide, to provide a sulfur trioxide rich gas
e. in a condensation step cooling said sulfur trioxide rich gas by heat exchange with a condenser heat exchange medium, to enable hydration of sulfur trioxide and condensation of sulfuric acid to provide a stream of concentrated sulfuric acid and a purified process gas, and
f. in a recycling step, directing at least a part of the purified process gas as said recycle gas.

2. A process according to claim 1 wherein said conditions efficient in oxidation of hydrogen sulfide to sulfur dioxide involve an elevated temperature.

3. A process according to claim 1 wherein said conditions efficient in oxidation of hydrogen sulfide to sulfur dioxide involve contact with a material catalytically active in oxidation of hydrogen sulfide to sulfur dioxide.

4. A process according to claim 1, wherein the amount of hydrogen sulfide in the process feed gas is at least 0.1 vol % or 0.5 vol % and less than 2 vol % or 3 vol %.

5. A process according to claim 1, wherein the amount of dioxygen in the purified process gas is at least 0.1 vol % or 0.5 vol % and less than 3 vol % or 5 vol %.

6. A process according to claim 1, wherein said material catalytic active in oxidation of hydrogen sulfide to sulfur dioxide comprises one or more oxides of a metal taken from the group consisting of vanadium, chromium, tungsten, molybdenum, cerium, niobium, manganese and copper on a support comprising one or more oxides of metals taken from the group of aluminum, silicon and titanium and a temperature being at least 200° C. or 220° C. and less than 500° C. or 550° C.

7. A process according to claim 1, wherein conditions efficient in catalytic oxidation of sulfur dioxide to sulfur trioxide involve a catalytically active material comprising vanadium pentoxide, sulfur in the form of sulfate, pyrosulfate, tri- or tetrasulfate and alkali metals, on a porous carrier and a temperature being at least 380° C. or 400° C. and less than 700° C. or 650° C.

8. A process according to claim 1, wherein heating said process gas comprising hydrogen sulfide involves one or both of heat exchange in a heat exchanger with a first hot process fluid and addition of a second hot process gas.

9. A process according to claim 1, wherein said first hot process fluid and second hot process fluid may be the same or different and may be taken from the group of a heat exchange medium including said condenser heat exchange medium, said sulfur dioxide rich gas, said sulfur trioxide rich gas and said purified process gas.

10. A process according to claim 1, wherein said process feed gas has a temperature such that the temperature of the sulfur dioxide rich gas is at least 370° C. and less than 420° C.

11. A process according to claim 1, wherein said aqueous solution comprising hydrogen sulfide is provided by microbiological reduction of sulfate.

12. A process according to claim 11, wherein at least an amount of the sulfuric acid produced is directed to be used in an upstream process producing sulfate.

13. A process according to claim 1, wherein at least an amount of the sulfuric acid produced is directed to be used for leaching of metal ore, to provide an aqueous solution comprising metal sulfate.

14. A process according to claim 1, wherein at least an amount of the sulfuric acid produced is directed to be used for hydrolysis of ligneous compounds.

15. A process plant comprising a vessel for contacting a liquid stream and a gas stream, having a liquid stream inlet and outlet and a gaseous stream inlet and outlet, a means for hydrogen sulfide oxidation and a sulfur dioxide reactor containing a material catalytically active in sulfur dioxide oxidation, each having an inlet and an outlet, and a condenser, having a cooling medium inlet and a cooling medium outlet, a gas inlet, a liquid outlet and a gas outlet, wherein the gas outlet of the vessel for contacting a liquid stream and a gas stream is in fluid communication with the inlet of the hydrogen sulfide oxidation reactor, the outlet of the hydrogen sulfide oxidation reactor is in fluid communication with the inlet of the sulfur dioxide oxidation reactor, the outlet of the sulfur dioxide oxidation reactor is in fluid communication with the gas inlet of the condenser and the gas outlet of the condenser is in fluid communication with the gaseous stream inlet of the vessel for contacting a liquid stream and a gas stream.
